(19) United States
(12) Patent Application Publication
(10) Pub. No.: US 2024/0321515 A1
(43) Pub. Date: Sep. 26, 2024

(54) COIL WINDING MACHINE AND COIL WINDING METHOD THEREOF

(71) Applicant: METAL INDUSTRIES RESEARCH AND DEVELOPMENT CENTRE, Kaohsiung (TW)

(72) Inventors: Ren-Yo HUANG, Kaohsiung (TW); Chih-Ping HSU, Kaohsiung (TW); Chien-Sheng HUANG, Kaohsiung (TW); Cheng-En WU, Kaohsiung (TW)

(21) Appl. No.: 18/465,697

(22) Filed: Sep. 12, 2023

(30) Foreign Application Priority Data
Mar. 21, 2023 (TW) 112110397

(51) Int. Cl. H01F 41/061; H01F 41/08; H01F 41/082; H01F 41/094

(52) U.S. Cl. CPC H01F 41/061; H01F 41/08; H01F 41/082; H01F 41/094

(57) ABSTRACT

A coil winding machine is adapted for winding a conductive flat wire onto an iron core. The coil winding machine includes a base, a tension mechanism mounted on the base and adapted for delivering the flat wire and providing tension to the flat wire, a rotary mechanism mounted on the base and including a core base that is rotatable and that is adapted to be mounted with the iron core, and at least one clamping mechanism mounted on the base, being co-rotatable with the core base, and operable for abutting the flat wire tightly against the iron core. A tension provided by the tension mechanism, a pressure provided by the clamping mechanism, and a rotational speed of the core base correspond to one another such that rotation of the core base and the at least one clamping mechanism winds the flat wire onto the iron core.

### CROSS-REFERENCE TO RELATED APPLICATION

This application claims priority to Taiwanese Invention Patent Application No. 112110397, filed on Mar. 21, 2023.

### FIELD

The disclosure relates to a coil winding machine, and more particularly to a coil winding machine and a coil winding method thereof.

### BACKGROUND

A conventional coil wire has a circular cross section, and a flat wire has a bigger aspect ratio than the conventional coil wire. Currently, there are two ways of winding the flat wire: horizontal winding and vertical winding. Horizontal winding is more commonly used than vertical winding, and is conducted by placing a longer side of the flat wire against an iron core and winding the flat wire around the iron core. A horizontally wound coil may be manufactured directly on the iron core or may be installed later onto the iron core after the horizontally wound coil is formed.

Heat dissipation of the horizontally wound coil is inferior compared to that of a vertically wound coil. The vertically wound coil may better resolve the problem of heat dissipation and improve output power. However, the vertically wound coil is first formed then installed onto the iron core, and therefore may not be manufactured directly onto the iron core, so gaps may exist between the vertically wound coil and the iron core. Furthermore, there is a 90 degree angle difference between the horizontal and vertical winding methods. That is to say, when winding the coil with a shorter side of the flat wire tightly abutted against the iron core, there is a discrepancy between an inner edge and an outer edge of the flat wire as the outer edge expands substantially and the inner edge contracts substantially, such that plastic deformation (e.g., creases) may appear, thereby increasing production difficulty. Hence, there is room for improvement.

### SUMMARY

Therefore, an object of the disclosure is to provide a coil winding machine that can alleviate at least one of the drawbacks of the prior art.

According to the disclosure, the coil winding machine includes a base, a tension mechanism, a rotary mechanism, and at least one clamping mechanism. The tension mechanism is mounted on the base, and is adapted for delivering the flat wire and providing tension to the flat wire. The rotary mechanism is mounted on the base, and includes a core base that is rotatable and that is adapted to be mounted with the iron core. The at least one clamping mechanism is mounted on the base, is co-rotatable with the core base, and is operable for abutting the flat wire tightly against the iron core. A tension provided by the tension mechanism, a pressure provided by the clamping mechanism, and a rotational speed of the core base correspond to one another such that rotation of the core base and the at least one clamping mechanism winds the flat wire onto the iron core.

Another object of the disclosure is to provide a coil winding method that can alleviate at least one of the drawbacks of the prior art. According to the disclosure, the coil winding method is adapted for winding a conductive flat wire onto an iron core, and includes the steps of: placing the flat wire at a lateral side of the iron core; operating a first clamping mechanism to abut the flat wire tightly against a lateral end of the iron core; and operating a tension mechanism to provide a tension to the flat wire to stretch taut the flat wire, and rotating simultaneously the iron core and the first clamping mechanism to bend the flat wire with the flat wire being maintained to abut tightly against the lateral end of the iron core.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an embodiment of the disclosure.

FIG. 2 is a fragmentary partly exploded perspective view of a tension mechanism, a rotary mechanism, and a clamping mechanism of the embodiment.

FIG. 3 is the flow chart demonstrating steps of the coil winding method of the embodiment of the disclosure.

FIGS. 4 to 15 are fragmented schematic views illustrating the steps for the coil winding method, where a base of the coil winding machine is omitted.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

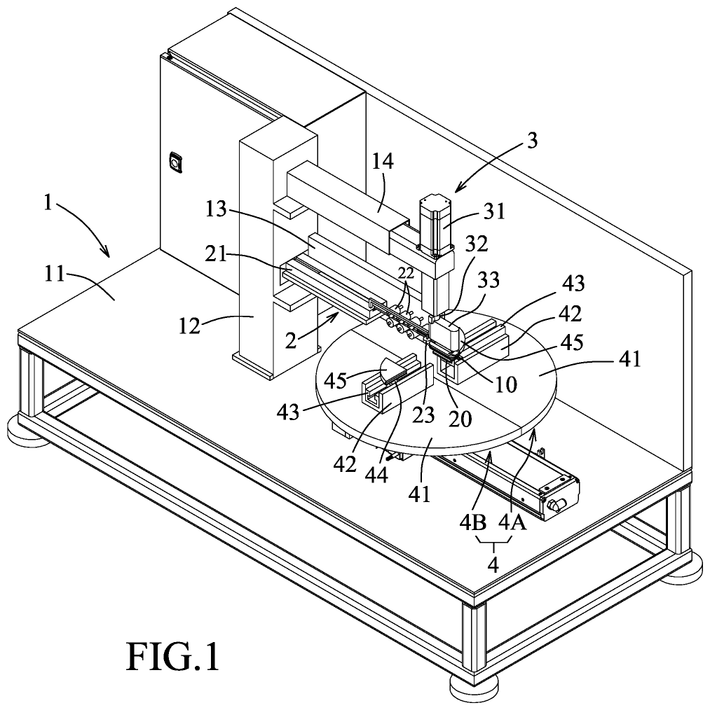

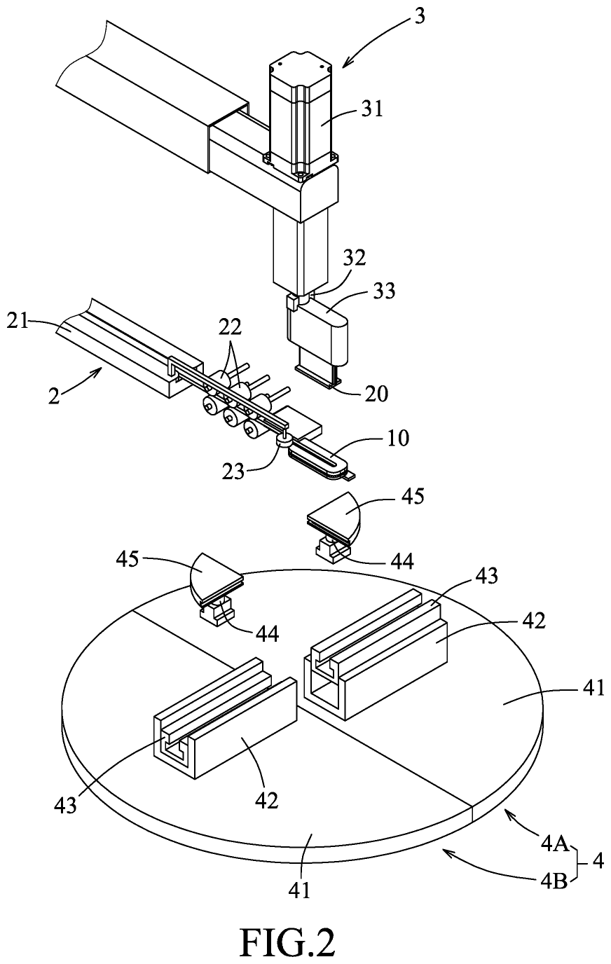

Referring to FIGS. 1 to 4, an embodiment of the coil winding machine is adapted for winding a conductive flat wire 10 onto an iron core 20. A material of the flat wire 10 may be pure copper, copper alloy, pure aluminum, aluminum alloy or gold, and may have electrical conductivity that ranges from 98% to 103%, from 75% to 88%, from 33% to 63% or in other ranges depending on properties of the flat wire 10. The coil winding machine includes a base 1, a tension mechanism 2, a rotary mechanism 3, and at least one clamping mechanism 4. In this embodiment, the at least one clamping mechanism 4 includes first and second clamping mechanisms 4A, 4B.

The base 1 includes a foundation 11, a mounting post 12 upwardly extending from the foundation 11, a mounting plate 13 installed on the mounting post 12 and extending horizontally, and a connecting block 14 installed on the mounting post 12, disposed above the mounting plate 13, and extending horizontally. The tension mechanism 2 is mounted on the base 1, and is adapted for delivering the flat wire 10 and providing tension to the flat wire 10. The tension mechanism 2 includes a delivering plate 21 mounted on the base 1 for delivering the flat wire 10, a plurality of rollers 22 installed on the mounting plate 13, and a driving member 23 connected to the delivering plate 21. The rollers 22 are installed such that they are divided into upper and bottom rows, thereby contacting the upper surface and the bottom surface of the flat wire 10, respectively. The driving member 23 is vertically movable for downwardly pushing the flat wire 10.

The rotary mechanism 3 is mounted on base 1, and includes a servomotor 31 mounted on the connecting block 14, a claw member 32 connected to the servomotor 31, and a core base 33 being rotatable and adapted to be mounted with the iron core 20. The claw member 32 grips the core base 33. The servomotor 31 is operable for driving rotation of the claw member 32, which in turn drives the rotation for the core base 33. The core base 33 has a first end 331 and a second end 332 opposite to the first end 331. The first and second clamping mechanisms 4A, 4B are mounted on the base 1, are co-rotatable with the core base 33, are disposed respectively at opposite sides of the core base 33, and are operable for alternately abutting the flat wire 10 tightly against the iron core 20. Each of the first and second clamping mechanisms 4A, 4B includes a semicircular turntable 41, a grooved exterior member 42 fixedly mounted on the turntable 41, a grooved interior member 43 installed in and vertically movable relative to the grooved exterior member 42, a sliding mount 44 installed in the grooved interior member 43 and being horizontally movable, and a clamping plate 45 fixed on the sliding mount 44 and operable for abutting the flat wire 10 tightly against the iron core 20. The turntable 41, the grooved interior member 43, and the sliding mount 44 may be driven by but not limited to, for example, air cylinders (not shown). The clamping plate 45 has a shape of a quadrant, and has two straight sides and a quadrantal side that is connected between the straight sides. Each of the straight sides is formed with a groove 451 adapted to be engaged with the flat wire 10 when the clamping plate 45 abuts the flat wire tightly against the iron core 20. A tension provided by the tension mechanism 2, a pressure provided by the clamping mechanism 4 and applied on the flat wire 10, and a rotational speed of the core base 33 of the rotary mechanism 3 correspond to one another, such that rotation of the core base 33 and the clamping mechanism 4 may wind the flat wire 10 onto the iron core 20. The purpose of the second clamping mechanism 4B is to increase efficiency as it is able to abut the flat wire 10 against the iron core 20 alternatively with the first clamping mechanism 4A. It should be noted that the second clamping mechanism 4B is not an essential component. In other embodiments, there may be only one clamping mechanism 4. The following describes the coil winding method of this embodiment.

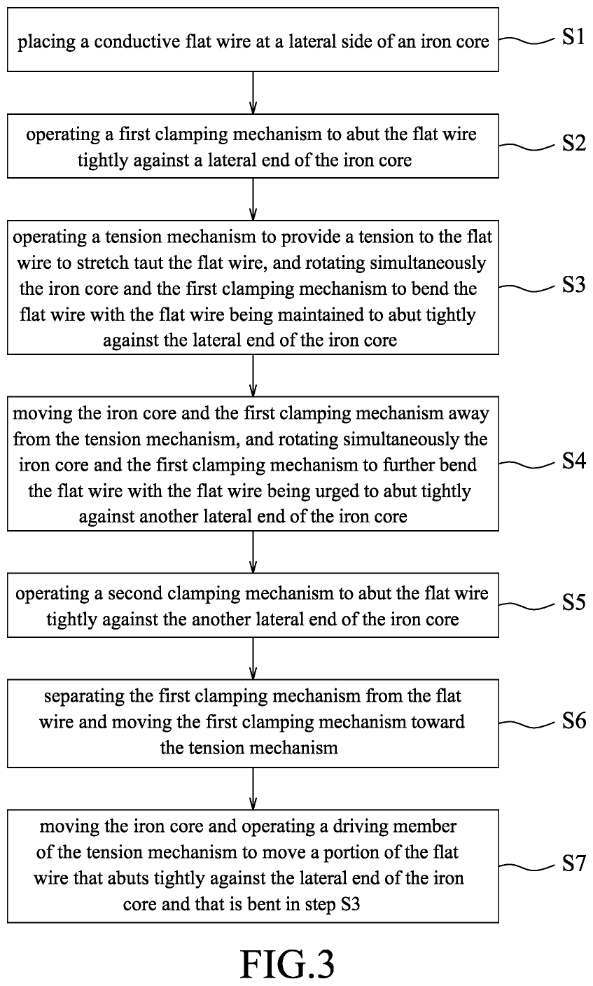

FIG. 3 illustrates the steps of the coil winding method of this embodiment and includes steps S1 to S7.

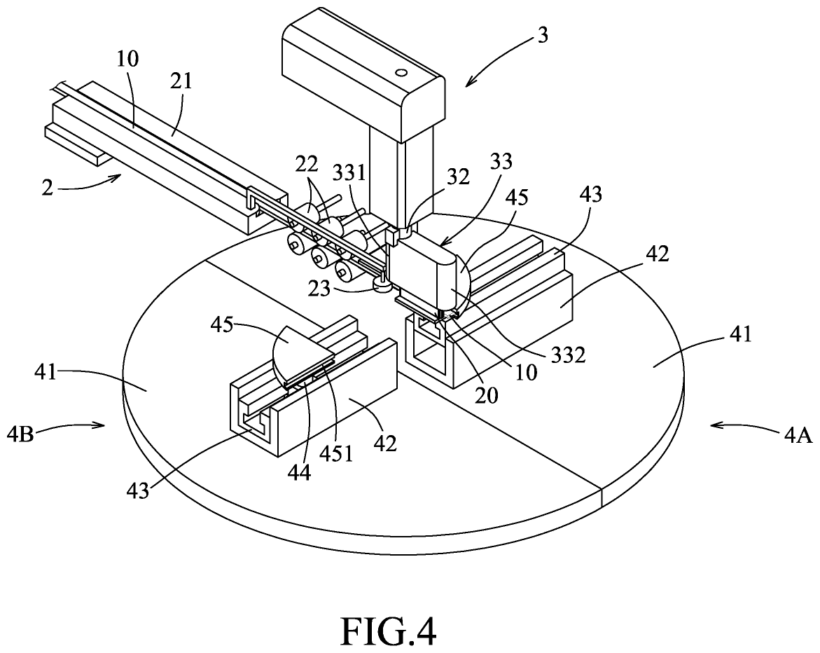

In step S1, referring to FIG. 4, a conductive flat wire 10 is placed at a lateral side of an iron core 20, and is disposed over the first clamping mechanism 4A.

Next, in step S2, the clamping mechanism 4A is operated to abut the flat wire 10 tightly against a lateral end of the iron core 20. In particular, the flat wire 10 engages with the groove 451 of the clamping plate 45 of the first clamping mechanism 4A. The iron core 20 has two opposite lateral ends connected to each other, and junctions of the lateral ends are filleted.

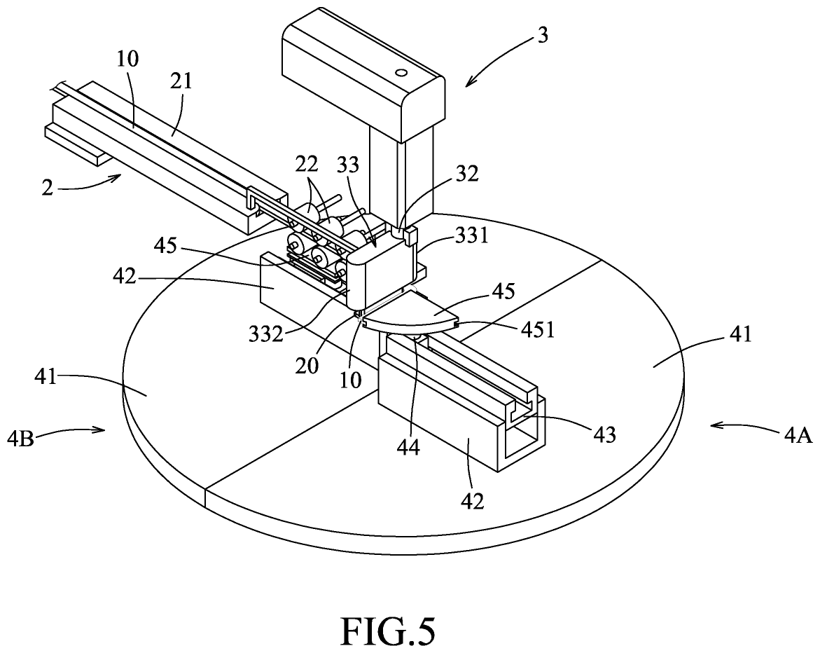

In step S3, referring to FIG. 5, the tension mechanism 2 is operated to provide tension to stretch taut the flat wire 10, and the iron core 20 and the first clamping mechanism 4A are simultaneously rotated to bend the flat wire 10 under the influence of tension, so that the flat wire 10 is maintained to abut tightly against the lateral end of the iron core 20. The flat wire 10 is consequently wound from the lateral end (i.e., a longer side) of the iron core 20 to a shorter side. In this process, through the fillet of the iron core 20, the rotational speed of the iron core 20, the tension of the flat wire 10 and the pressure from the clamping in the flat wire 10 correspond with one another, the coil may complete this winding step, and a discrepancy between inner and outer diameters of the flat wire 10 is overcome.

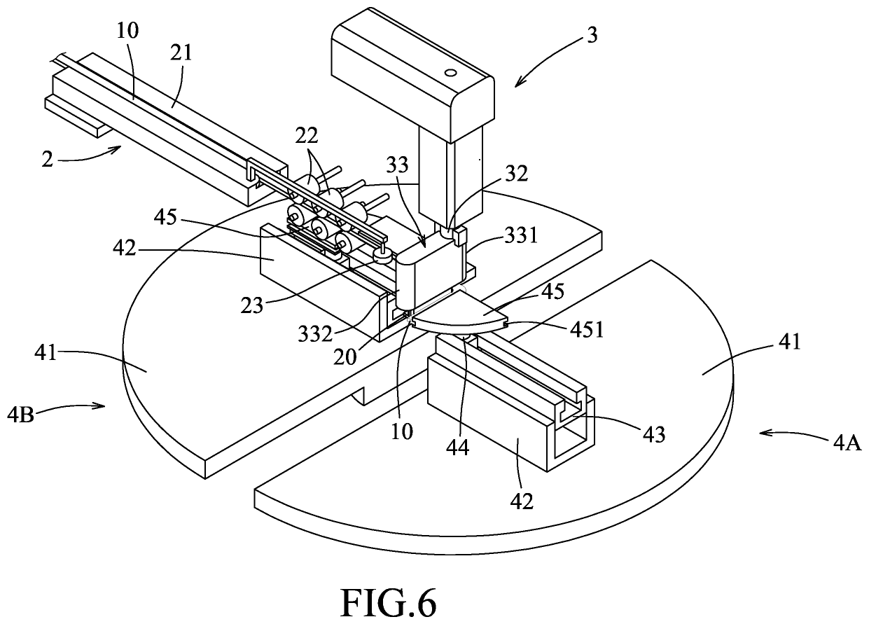

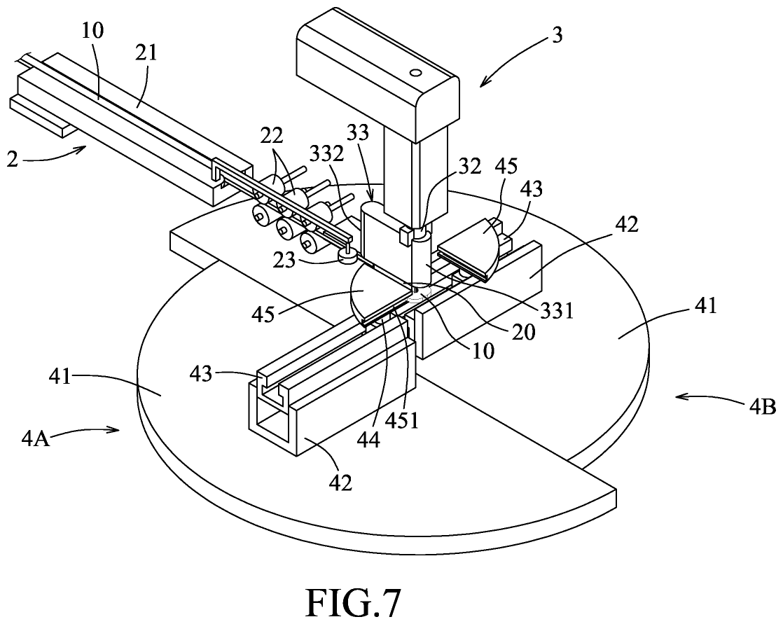

In step S4, referring to FIGS. 6 and 7, the iron core 20 and the first clamping mechanism 4A are moved away from the tension mechanism 2, and the iron core 20 and the first clamping mechanism 4A are rotated simultaneously as shown in step S3 so as to further bend the flat wire 10 and tightly abut it to the iron core 20. Specifically, to provide sufficient space for rotation, and to avoid interference with other members while the core base 33 and the iron core 20 are rotating, the iron core 20 and the first clamping mechanism 4A are moved away from the tension mechanism 2. Then, through a correspondence of the fillet of the iron core 20, the rotational speed of the iron core 20, the tension of the flat wire 10, and the pressure from the clamping in the flat wire 10, the flat wire 10 is further wound from the shorter side of the iron core 20 to the another lateral end (i.e., the other longer side) of the iron core 20.

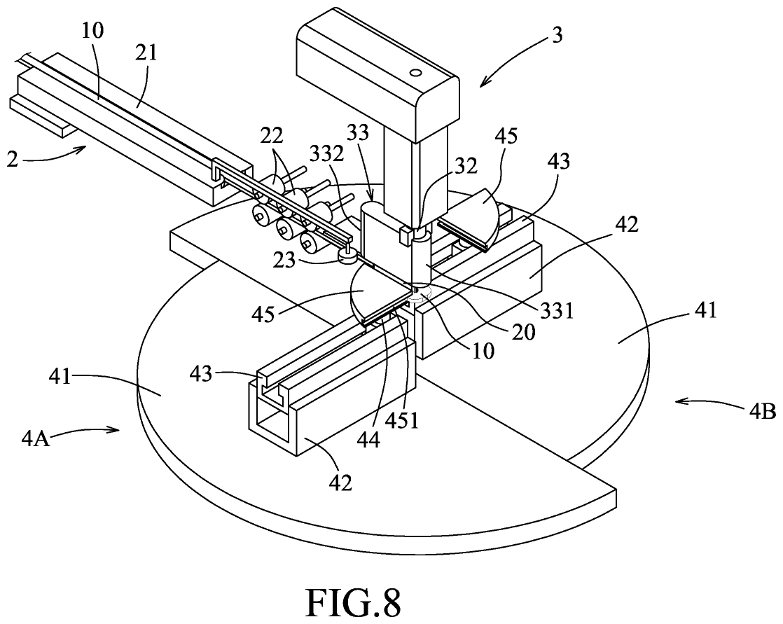

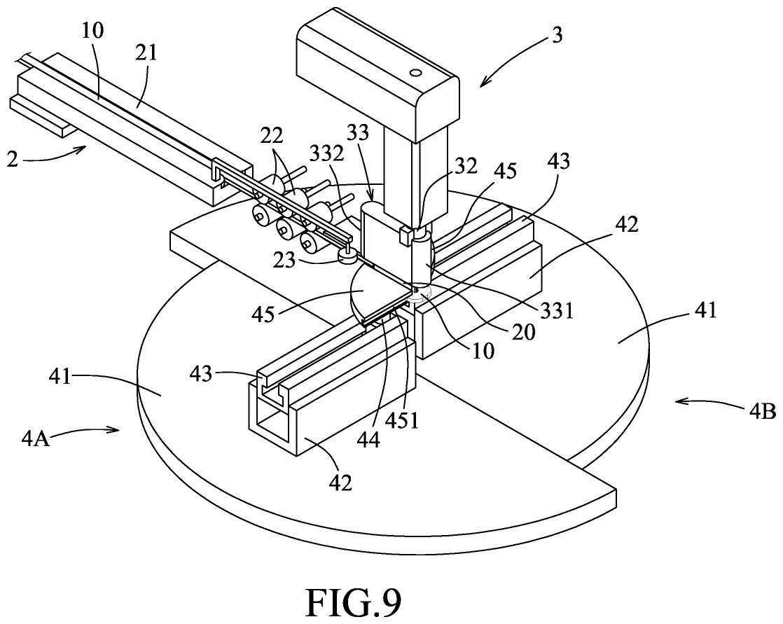

In step S5, referring to FIGS. 8 and 9, the second clamping mechanism 4B is operated to tightly abut the flat wire 10 against the another lateral end of the iron core 20. Specifically, given that the iron core 20 has completed three-fourths of a turn, the first clamping mechanism 4A and the second clamping mechanism 4B have also rotated by 180 degrees, now the second clamping mechanism 4B is on the same side as the side which delivers the flat wire 10. At this time, the second clamping mechanism 4B may be used to clamp the flat wire 10 as the flat wire 10 is delivered from the tension mechanism 2, thereby increasing the efficiency of coil winding by alternating clamping. Details of step S5 includes moving upwardly the grooved interior member 43 of the second clamping mechanism 4B as shown in FIG. 8, and moving the sliding mount 44 of the second clamping mechanism 4B towards the flat wire 10 until the clamping plate 45 of the second clamping mechanism 4B engages with the flat wire 10, as shown in FIG. 9.

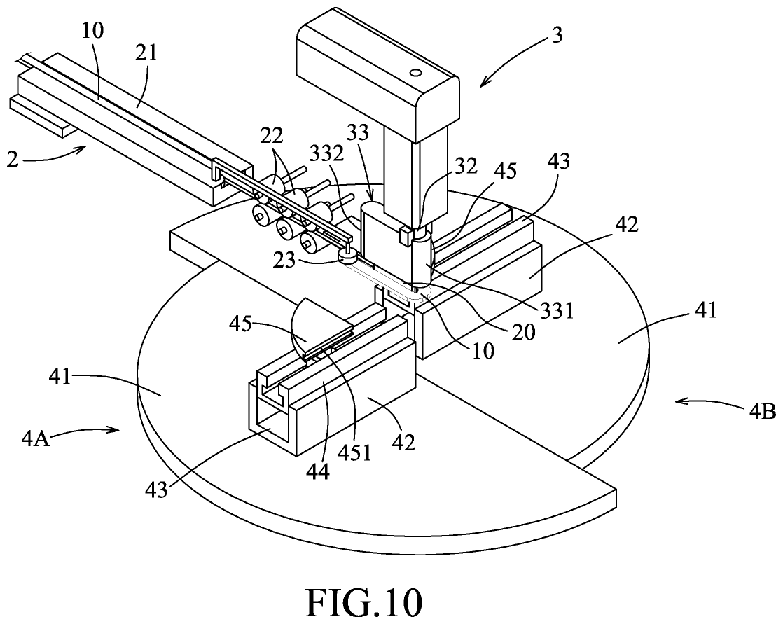

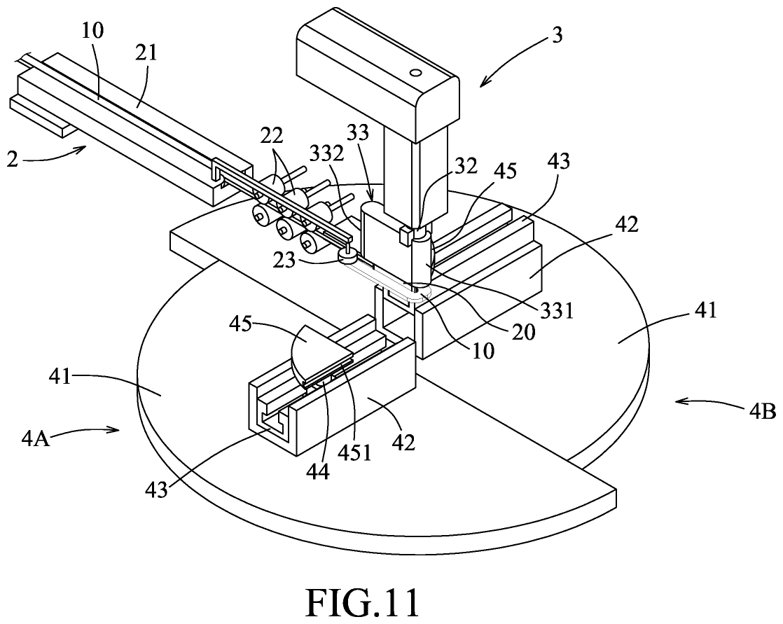

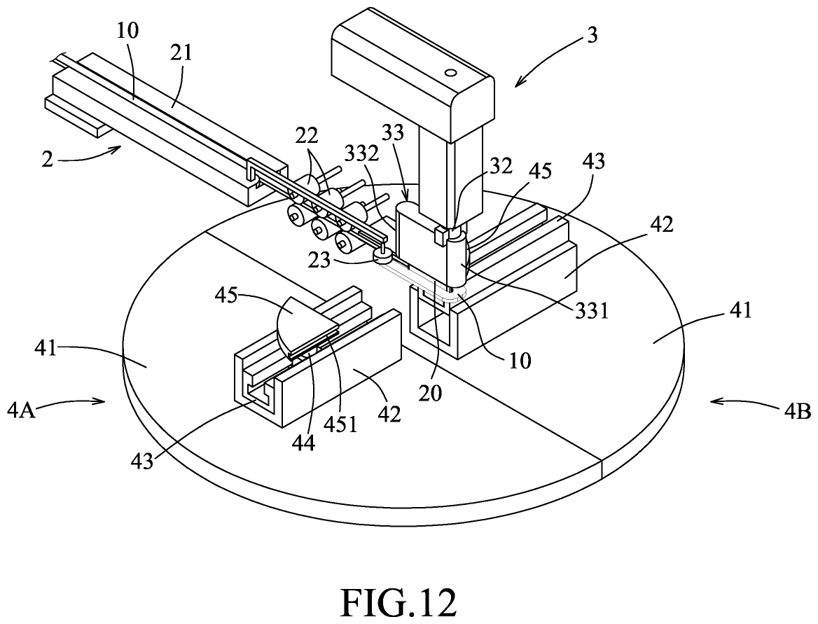

In step S6, referring to FIGS. 10 to 12, given the flat wire 10 is clamped between the second clamping mechanism 4B and the iron core 20, the first clamping mechanism 4A is converted to its non-clamping state and is moved towards the tension mechanism 2 so as to reset its position. Specifically, the sliding mount 44 of the first clamping mechanism 4A is moved away from the flat wire 10, as shown in FIG. 10. Next, the grooved interior member 43 is downwardly moved, as shown in FIG. 11. Lastly, the position of the turntable 41 of the first clamping mechanism 4A is reset by moving towards the tension mechanism 2, as shown in FIG. 12.

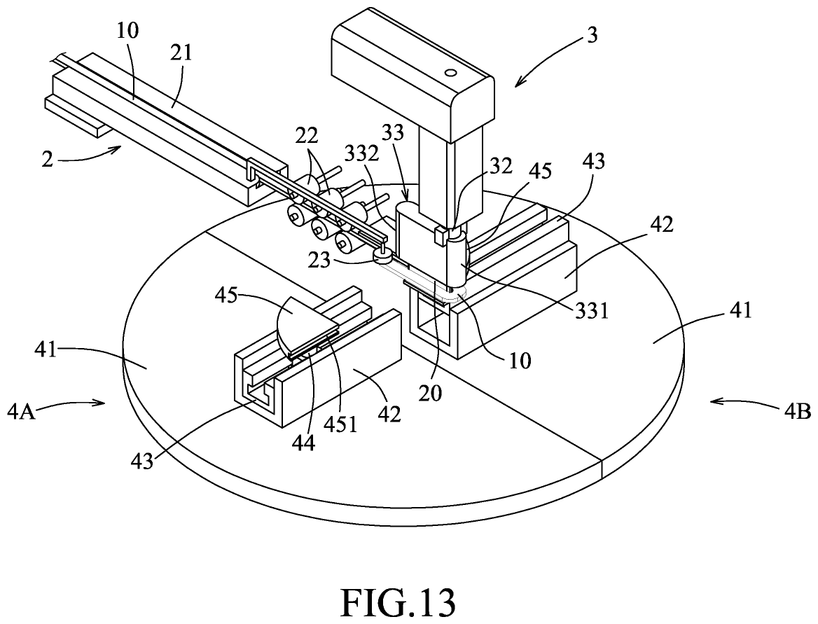

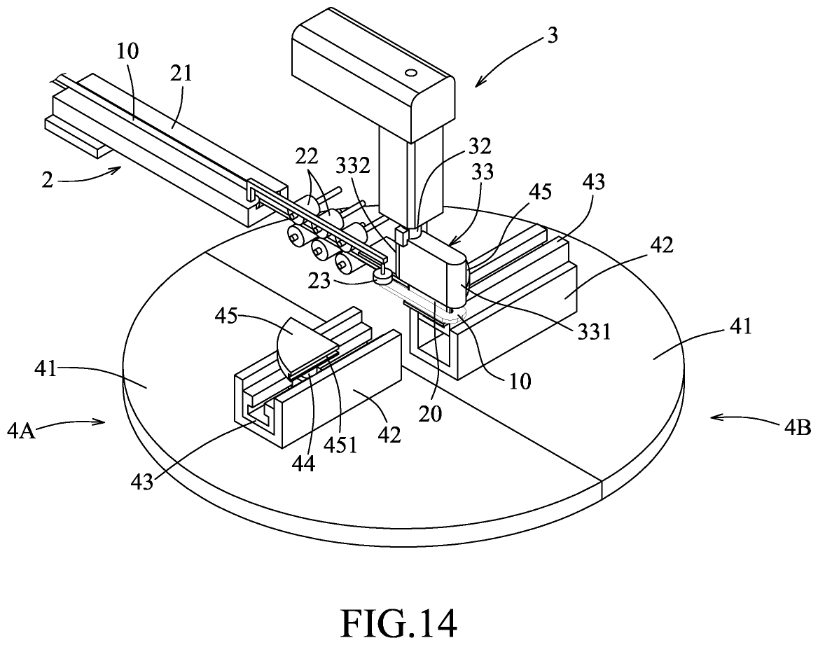

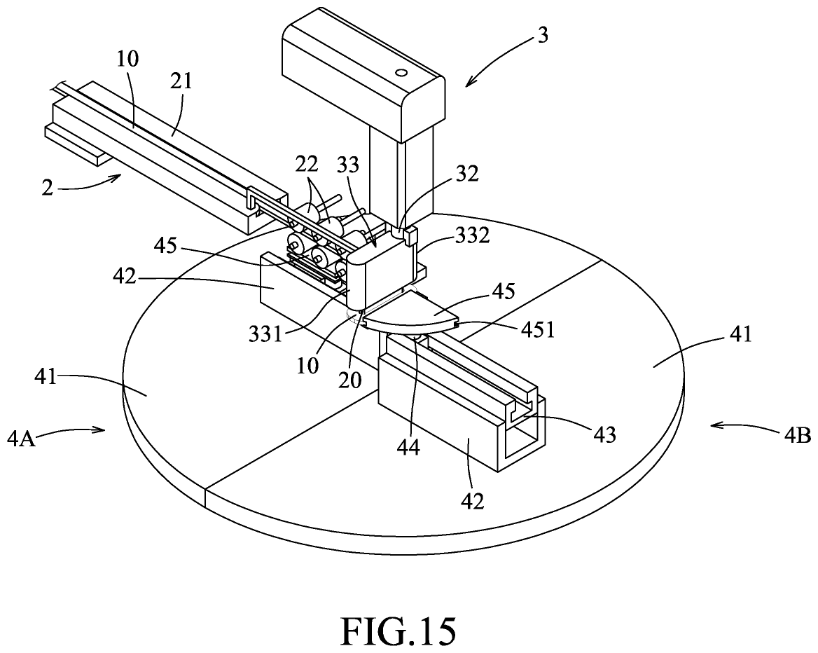

In step S7, referring to FIGS. 13 and 14, the iron core 20 is moved downwardly and the driving member 23 is operated to push downwardly the portion of the flat wire 10 that is directly underneath the driving member 23, that abuts tightly against the lateral end of the iron core 20, and that is bent in step S3. Specifically, the iron core 20 is moved downwardly to make space for the next turn, the claw member 32 is moved towards the tension mechanism 2 while repositioning its grip from the first end 331 to the second end 332 to ensure that the center of rotation is identical to the first turn of the flat wire 10, and the driving member 23 pushes downwardly the flat wire 10 to prevent interference with the first turn of the flat wire 10 wound onto the iron core 20. It should be noted that while the driving member 23 pushes the flat wire 10 in this embodiment, other methods of moving the flat wire 10 may be utilized in other embodiments. The flat wire 10 may be further wound onto the iron core 20 as referred in the previous step S3, as shown in FIG. 15. Then, the driving member 23 is reset to its original position after the flat wire 10 is further wound around the iron core 20. It should be noted that through the use of the servomotor 31, the gap between the first turn of the flat wire 10 and the second turn of the flat wire 10 shrinks, or even disappears.

While the embodiment of this disclosure discusses a coil winding machine for flat wires, a person having ordinary skill in the art can easily understand that the coil winding machine and the coil winding method thereof is applicable to other types of wires, such as round wires or Litz wires.

In summary, the coil winding machine of the disclosure uses the tension mechanism 2 to provide tension to the flat wire 10, and by virtue of the clamping mechanism 4 clamping the flat wire 10 tightly against the iron core 20, the core base 33 of the rotary mechanism 3 and the clamping mechanism 4 co-rotating, and the tension of the tension mechanism 2, the pressure of the clamping mechanism 4, and the rotational speed of the core base 33 of the rotary mechanism 3 corresponding to one another, the flat wire 10 may be wound onto the iron core 20 while avoiding plastic deformation such as creases, thereby increasing a slot filling rate of the coil. Thus, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A coil winding machine adapted for winding a conductive flat wire onto an iron core, said coil winding machine comprising:
a base;
a tension mechanism mounted on said base, and adapted for delivering the flat wire and providing tension to the flat wire;
a rotary mechanism mounted on said base, and including a core base that is rotatable and that is adapted to be mounted with the iron core; and
at least one clamping mechanism mounted on said base, being co-rotatable with said core base, and operable for abutting the flat wire tightly against the iron core;
wherein a tension provided by said tension mechanism, a pressure provided by said clamping mechanism, and a rotational speed of said core base correspond to one another such that rotation of said core base and said at least one clamping mechanism winds the flat wire onto the iron core.

2. The coil winding machine as claimed in claim 1, wherein said at least one clamping mechanism includes two clamping mechanisms that are disposed respectively at opposite sides of said core base and that are operable for alternately abutting the flat wire tightly against the iron core.

3. The coil winding machine as claimed in claim 2, wherein said tension mechanism includes:
a delivering plate that is mounted on said base for delivering the flat wire; and
a driving member that is connected to said delivering plate and that is vertically movable for downwardly pushing the flat wire.

4. The coil winding machine as claimed in claim 1, wherein:
said rotary mechanism includes a servomotor mounted on said base, and a claw member connected to said servomotor and grips said core base; and
said servomotor is operable for driving rotation of said claw member and said core base.

5. The coil winding machine as claimed in claim 1, wherein:
said at least one clamping mechanism includes a clamping plate that is operable for abutting the flat wire tightly against the iron core; and
said clamping plate is formed with a groove that is adapted to be engaged with the flat wire when said clamping plate abuts the flat wire tightly against the iron core.

6. A coil winding method adapted for winding a conductive flat wire onto an iron core, said coil winding method comprising the steps of:
placing the flat wire at a lateral side of the iron core;
operating a first clamping mechanism to abut the flat wire tightly against a lateral end of the iron core; and
operating a tension mechanism to provide a tension to the flat wire to stretch taut the flat wire, and rotating simultaneously the iron core and the first clamping mechanism to bend the flat wire with the flat wire being maintained to abut tightly against the lateral end of the iron core.

7. The coil winding method as claimed in claim 6, further comprising the step of:
moving the iron core and the first clamping mechanism away from the tension mechanism, and rotating simultaneously the iron core and the first clamping mechanism to further bend the flat wire with the flat wire being urged to abut tightly against another lateral end of the iron core.

8. The coil winding method as claimed in claim 7, further comprising the step of:
operating a second clamping mechanism to abut the flat wire tightly against the another lateral end of the iron core.

9. The coil winding method as claimed in claim 8, further comprising the step of:
separating the first clamping mechanism from the flat wire and moving the first clamping mechanism toward the tension mechanism.

10. The coil winding method as claimed in claim 9, further comprising the step of:
moving the iron core and operating a driving member of the tension mechanism to move a portion of the flat wire that abuts tightly against the lateral end of the iron core and that is bent in said step.
